(19) United States
(12) Patent Application Publication
(10) Pub. No.: US 2008/0080849 A1
(43) Pub. Date: Apr. 3, 2008

(54) AUTO-FOCUS IMAGING SYSTEM

(75) Inventor: JEN-TSORNG CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,990

(22) Filed: Dec. 29, 2006

(30) Foreign Application Priority Data
Sep. 28, 2006 (CN) 200610200947.2

(51) Int. Cl. G03B 3/10

(52) U.S. Cl. 396/133

(57) ABSTRACT

An exemplary auto-focus imaging system includes a barrel holder, a barrel, at least one lens received in the barrel, an image sensor, and a number of driving arms. The barrel and the image sensor are all received in the holder. The lens has an optical axis. The driving arms are interconnected between the holder and the barrel, and are made of volume changing conductive polymer.

### BACKGROUND

1. Technical Field

The present invention relates generally to the optical imaging field and, more particularly to an auto-focus imaging system.

2. Description of Related Art

Auto-focus techniques have been widely employed in various imaging systems, including still camera systems and video camera systems. Nowadays there are basically two main auto-focus methods: one is an active focus (i.e., distance metering) method, and the other is a passive focus (i.e., focus detection) method. In particular, the passive focus method mainly employs a charge-coupled device (CCD) and works by evaluating the amount of contrast or the phase difference in a scene. The active focus method usually uses an infrared light or ultrasound emitter and a corresponding receiver in a triangular surveying system, the data thus generated being converted by a microprocessor (e.g., a well-known digital signal processor) into information about distance and thereby enabling automatic focusing by an auto-focus imaging system.

Generally, a digital auto-focus camera system includes an optical imaging assembly, an image sensor, a control unit, and an actuator. The optical imaging assembly usually includes a movable lens assembly. The image sensor can be a CCD or a complementary metal oxide semiconductor device (CMOS). The control unit can be, for example, a digital signal processor or an image signal processor. The actuator commonly includes a stepper motor and a drive circuitry. The drive circuitry, regulated by the control unit, can drive the stepper motor to perform a rotational movement. In order to carry out the position adjustment of the movable lens assembly in an automatic focusing process, a gear assembly has necessarily been employed in the lens movement system to transform the rotational movement of the stepper motor into linear movement. However, the existence of the gear assembly generally makes the lens positioning system unduly bulky. Furthermore, the occurrence of backlash/recoil of the gear assembly will usually result in a degraded focusing accuracy.

It is therefore desirable to find a new auto-focus imaging system, which can overcome the above mentioned problems.

### SUMMARY

In a preferred embodiment, an auto-focus imaging system includes a barrel holder, a barrel, at least one lens received in the barrel, an image sensor, and a number of driving arms. The barrel and the image sensor are all received in the holder. The lens has an optical axis. The driving arms are interconnected between the holder and the barrel, and are made of volume changing conductive polymer.

### BRIEF DESCRIPTION OF THE DRAWINGS

Many aspects of embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, cross-sectional view of an auto-focus imaging system according to a first embodiment;

FIG. 2 is a schematic, cross-sectional view of a plurality of driving arms being electrically connected with a control unit in the imaging system of FIG. 1;

FIG. 3 is a schematic, cross-sectional view of an auto-focus imaging system according to a second embodiment; and

FIG. 4 is a schematic, plan view of a plurality of driving arms being fasten to a metal frame in the imaging system of FIG. 3.

### DETAILED DESCRIPTION OF THE EMBODIMENTS

Embodiments will now be described in detail below with reference to the drawings.

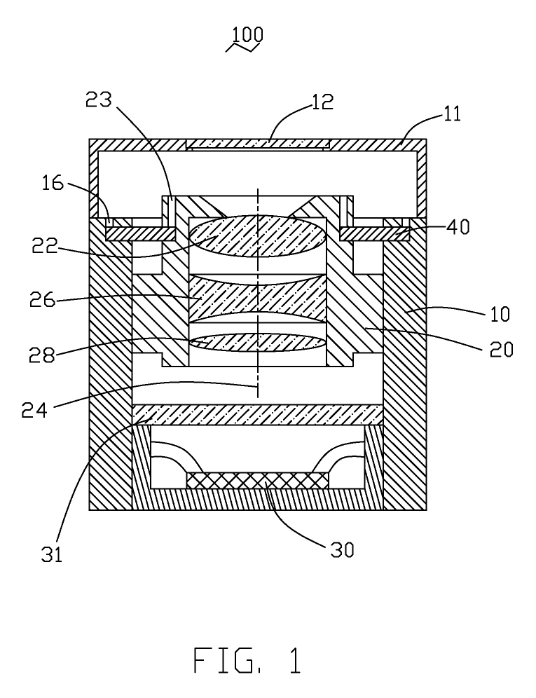

Referring to FIG. 1, an auto-focus imaging system 100 according to a first embodiment is shown. The imaging system 100 includes a barrel holder 10, a barrel 20 with a plurality of lenses 22, 26, and 28 received in the barrel 20, an image sensor 30, and a plurality of driving arms 40. The lenses 22, 26, and 28 have an essentially identical optical axis 24.

The barrel 20 and the image sensor 30 are received in the holder 10. A cover 11 can be applied on a top of the barrel 20, thus preventing the lenses 22, 26, and 28 from becoming polluted. The cover 11 should include a transparent part 12 in the center so that light can pass therethrough. A transparent plate 31 can be formed on the image sensor 30, and prevents the image sensor 30 from becoming polluted. The image sensor 30 can be a CCD or a CMOS device.

The arms 40 are interconnected between the holder 10 and the barrel 20, and are configured (i.e., structured and arranged) for driving the barrel 20 to move along the optical axis 24. Each of the arms 40 is made of volume changing conductive polymer. The volume changing conductive polymer can be, for example, polypyrrole, polyaniline, or polythiophene. Upper surfaces of the arms 40 can be disposed on an essentially identical plane perpendicular to the optical axis 24, and the arms 40 can be separated by equal angles around the barrel 20. The holder 10 can have a plurality of holes 16 defined at a top of the holder 10 so that glue can be dispensed into the holes 16 thus securing the arms 40 to the holder 10. Also, the barrel 20 can have a plurality of holes 23 defined at a top of the barrel 20 so that glue can be dispensed into the holes 23, accordingly fastening the arms 40 to the barrel 10.

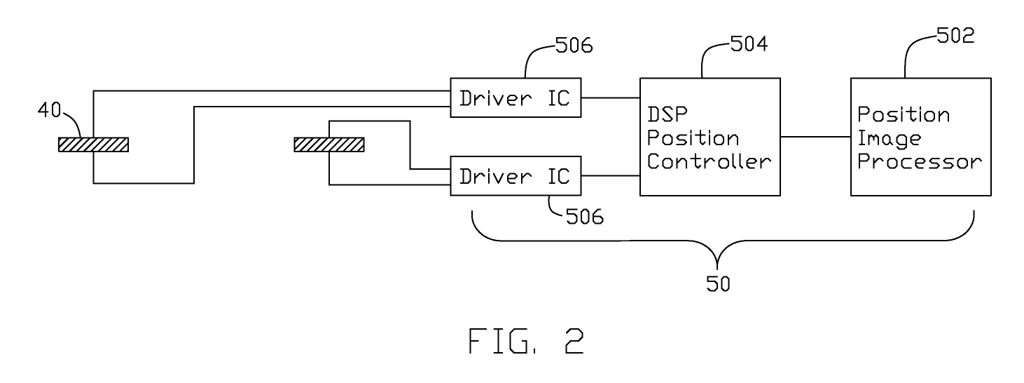

Referring to FIGS. 1 and 2, the arms 40 are all electrically connected to a control unit 50 in parallel. The control unit 50 feeds a voltage to each of the arms 40, and then the arms 40 bend upwards or downwards along the optical axis 24 in response to the voltage. The control unit 50 includes a position image processor 502, a digital signal processor (DSP) position controller 504, and a driver integrated circuit (IC) 506.

The way in which the auto-focus imaging system 100 works will be described as follows. First, the position image processor 502 detects a current position of the barrel 20 and sends a signal to the DSP position controller 504. Based on the signal, the DSP position controller 504 determines a distance that the barrel 20 needs to move in order to achieve an appropriate focus, and then sends another signal to the driver IC 506. Then the driver IC 506 feeds a first voltage to each of the arms 40, and then each of the arms 40 bends upwards along the optical axis 24 in response to the voltage. Therefore, the barrel 20 is moved upwards along the optical axis 24. In other words, the image sensor 30 is moved away from the barrel 20 and achieves an appropriate focus. Likewise, when the driver IC 506 feeds a second voltage to each of the arms 40, then each of the arms 40 bends downwards along the optical axis 24 in response to the voltage. Therefore, the barrel 20 is moved downwards along the optical axis 24. In other words, the image sensor 30 is moved towards the barrel 20 to achieve an appropriate focus. Because of the usage of the driving arms 40, the auto-focus imaging system 100 has a compact configuration.

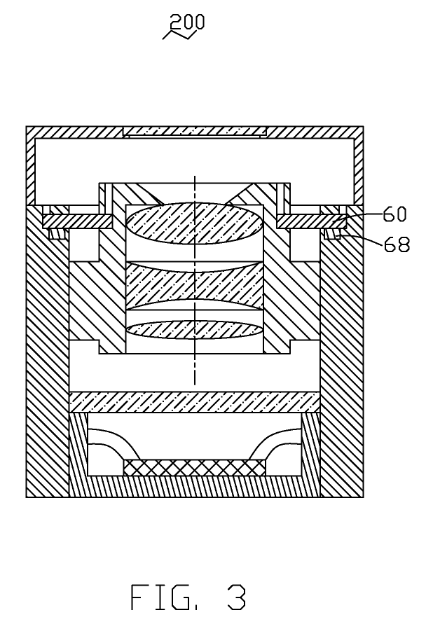

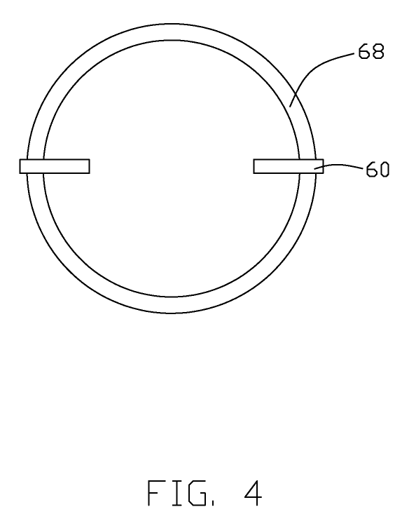

Referring to FIGS. 3 and 4, another auto-focus imaging system 200 according to a second embodiment is shown. The auto-focus imaging system 200 is similar to the system 100, but each of the arms 60 is fastened to a ring-shaped metal frame 68 along a radius of the frame 44 for ease of assembly.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An auto-focus imaging system comprising:
a barrel;
a barrel holder receiving the barrel therein;
at least one lens having an optical axis associated therewith received in the barrel;
an image sensor disposed adjacent to the barrel; and
a plurality of driving arms interconnected between the holder and the barrel, wherein each of the driving arms is made of volume changing conductive polymer.

2. The auto-focus imaging system as claimed in claim 1, wherein upper surfaces of the driving arms are disposed on an essentially identical plane perpendicular to the optical axis.

3. The auto-focus imaging system as claimed in claim 1, wherein the driving arms are equally angularly spaced from one another around the barrel.

4. The auto-focus imaging system as claimed in claim 1, further comprising a ring-shaped frame, wherein each of the driving arms is attached to the frame along a radius of the frame, and the frame is fixed on the barrel.

5. The auto-focus imaging system as claimed in claim 4, wherein the driving arms are equally angularly spaced from one another.

6. The auto-focus imaging system as claimed in claim 1, further comprising a control unit wherein each of the driving arms is electrically connected to the control unit, and the control unit is configured for applying a voltage to each of the driving arms.

7. The auto-focus imaging system as claimed in claim 6, wherein the driving arms are connected to the control unit in parallel.

8. The auto-focus imaging system as claimed in claim 1, wherein the volume changing conductive polymer is selected from the group consisting of polypyrrole, polyaniline, and polythiophene.
